(19) United States
(12) Patent Application Publication
(10) Pub. No.: US 2017/0185949 A1
(43) Pub. Date: Jun. 29, 2017

(54) METHODS AND APPARATUS FOR MANAGING ASSETS USING SERVICE TAGS

(71) Applicants: Martin Paul Mayhead, Hindhead (GB); Michael J. Wookey, Los Gatos, CA (US)

(72) Inventors: Martin Paul Mayhead, Hindhead (GB); Michael J. Wookey, Los Gatos, CA (US)

(21) Appl. No.: 11/956,842

(22) Filed: Dec. 14, 2007

(51) Int. Cl. G06Q 10/08; G06Q 99/00

(52) U.S. Cl. CPC G06Q 10/087

(57) ABSTRACT

A system identifies at least one asset of a computer system. The system identifies asset information associated with at least one asset. The system creates a service tag on the computer system using the asset information. The service tag is associated with at least one asset. The service tag includes context information associated with at least one asset. The context information includes a context in which the asset is used.

### RELATION TO OTHER APPLICATIONS

This application relates to the following applications filed on the same date as the present application:

i) U.S. patent application Ser. No./ ______, entitled “METHODS AND APPARATUS FOR DISCOVERY DRIVEN PRODUCT REGISTRATION” [Attorney Docket No. SUN07-31(070277)]

ii) U.S. patent application Ser. No./ ______, entitled “ADMINISTRATIVE GROUPING OF NETWORK RESOURCES” [Attorney Docket No. SUN07-30(070279)]

The teachings and disclosure of the above co-filed applications are each incorporated by reference herein in their entirety.

### BACKGROUND

Conventional technologies for asset management identify hardware assets such as computer systems, etc., via a unique serial number associated with the hardware assets. Asset management technologies may also identify individual software packages that are installed on individual computer systems. Often software packages are licensed to be installed on a plurality of computer systems using the same serial number for all instances of the software package loaded on the plurality of computer systems (sometimes referred to as a multi-seat license). For example, during installation of the software package, the user performing the installation is prompted to enter a ‘key’. The ‘key’ is a unique alpha numerical character string that is provided by the software package manufacturer.

### SUMMARY

Conventional technologies for asset management suffer from a variety of deficiencies. In particular, conventional technologies related to asset management are limited in that they may not attempt or be able to reliably track each and every asset. For example, conventional technologies for asset management may not track each instance of a software package installed on each computer system, especially when the same software package is installed on a plurality of computer systems. Conventional technologies for asset management do not keep track of which assets (i.e., hardware and/or software) have been registered, nor may conventional technologies for asset management keep track of versions of assets, updates to the assets, etc. Conventional technologies for asset management do not provide relevant information associated with the asset such as environmental information or contextual information associated with the asset.

Embodiments disclosed herein significantly overcome such deficiencies and provide a system that includes a computer system executing an asset managing process that identifies each asset in the network, including, for example, each instance of software loaded on a computer system. The asset managing process identifies asset information associated with each asset and creates a service tag using the asset information. A supplier of the assets may use the identity information contained within the service tag to determine a level of service the asset is authorized to receive. The service tag may also be used to provide asset information to a user, and also to track transfer of ownership of the asset (i.e., when the asset is transferred from a previous user to a new user). In an example embodiment, the service tag is created when an action is performed on the asset, such as installation, deployment, and/or updating the asset. The service tag may also be used during the task of registering the asset. A service tag may be created and maintained by the asset itself or by an agent that creates the service tags and maintains a registry of service tags.

The asset managing process identifies at least one asset of a computer system. The asset managing process identifies asset information associated with at least one asset, and creates a service tag on the computer system using the asset information. The service tag is associated with at least one asset. The service tag includes context information associated with at least one asset. The context information includes a context in which the asset is used.

Other embodiments disclosed herein include any type of computerized device, workstation, handheld or laptop computer, or the like configured with software and/or circuitry (e.g., a processor) to process any or all of the method operations disclosed herein. In other words, a computerized device such as a computer or a data communications device or any type of processor that is programmed or configured to operate as explained herein is considered an embodiment disclosed herein.

Other embodiments disclosed herein include software programs to perform the steps and operations summarized above and disclosed in detail below. One such embodiment comprises a computer program product that has a computer-readable medium including computer program logic encoded thereon that, when performed in a computerized device having a coupling of a memory and a processor, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained as embodiments disclosed herein.

It is to be understood that the system disclosed herein may be embodied strictly as a software program, as software and hardware, or as hardware alone. The embodiments disclosed herein, may be employed in data communications devices and other computerized devices and software systems for such devices such as those manufactured by Sun Microsystems, Inc. of Santa Clara, Calif.

### BRIEF DESCRIPTION OF THE DRAWINGS

The foregoing will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 is a block diagram according to one embodiment disclosed herein.

FIG. 2 shows a high-level block diagram of a computer system according to one embodiment disclosed herein.

FIG. 3 illustrates a flowchart of a procedure performed by the system of FIG. 1, when the asset managing process identifies at least one asset of a computer system, according to one embodiment disclosed herein.

FIG. 4 illustrates a flowchart of a procedure performed by the system of FIG. 1, when the asset managing process creates a service tag on the computer system using the asset information, according to one embodiment disclosed herein.

FIG. 5 illustrates a flowchart of a procedure performed by the system of FIG. 1, when the asset managing process triggers creation of the service tag as a result of an action associated with at least one asset, according to one embodiment disclosed herein.

FIG. 6 illustrates a flowchart of a procedure performed by the system of FIG. 1, when the asset managing process creates a service tag on the computer system using the asset information, and determines the asset is comprised of a plurality of components, according to one embodiment disclosed herein.

FIG. 7 illustrates a flowchart of a procedure performed by the system of FIG. 1, when the asset managing process creates a service tag on the computer system using the asset information, and generates a unique identifier with which to identify the asset, according to one embodiment disclosed herein.

FIG. 8 illustrates a flowchart of a procedure performed by the system of FIG. 1, when the asset managing process creates a service tag on the computer system using the asset information, and determines that a unique identifier associated with the service tag no longer exists, according to one embodiment disclosed herein.

### DETAILED DESCRIPTION

Embodiments disclosed herein include a computer system executing an asset managing process that identifies each asset in the network, including, for example, each instance of software loaded on a computer system. The asset managing process identifies asset information associated with each asset and creates a service tag using the asset information. An agent creates the service tag. A supplier of the assets may use the service tag to determine a level of service the asset is authorized to receive. The service tag may also be used to provide asset information to a user, and also to track transfer of ownership of the asset. The service tag may also be used during the process of registering the asset.

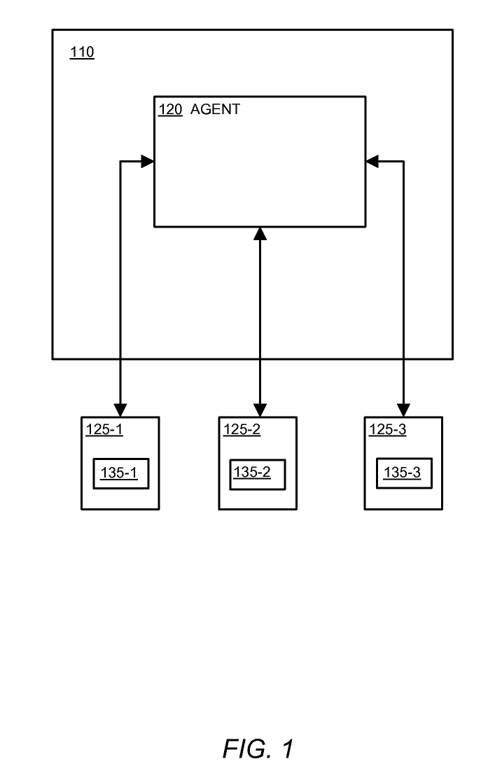

FIG. 1 illustrates a block diagram according to one embodiment disclosed herein. The asset managing process 140-2 operates on a computer system 110 that includes an agent 120. The agent discovers assets 125-1, 125-2 and 125-3 on the network. The agent 120 identifies asset information associated with the assets 125-1, 125-2 and 125-3. The agent creates a service tag 135-1, 135-2 and 135-3 associated with the respective asset 125-1, 125-2 and 125-3.

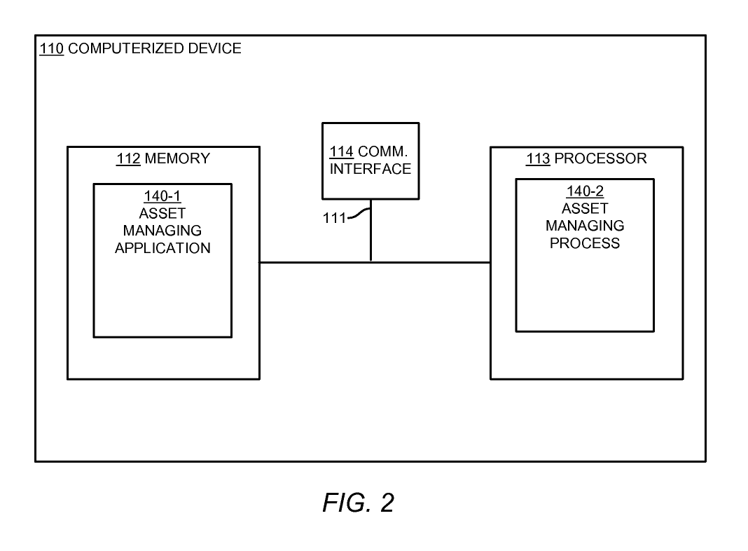

FIG. 2 illustrates an example architecture of a computer system 110. The computer system 110 may be any type of computerized device such as a personal computer, workstation, portable computing device, console, laptop, network terminal or the like. In this example, the computer system 110 includes an interconnection mechanism 111 that couples a memory system 112, a processor 113, and a communications interface 114. The communications interface 114 enables the computer system 110 to communicate with other devices (i.e., other computers) on a network (not shown). This can allow access to asset managing application 140-1 by remote computer systems.

The memory system 112 may be any type of computer readable medium that is encoded with an asset managing application 140-1 that may be embodied as software code such as data and/or logic instructions (e.g., code stored in the memory or on another computer readable medium such as a removable disk) that supports processing functionality according to different embodiments described herein. During operation of the computer system 110, the processor 113 accesses the memory system 112 via the interconnect 111 in order to launch, run, execute, interpret or otherwise perform the logic instructions of the asset managing application 140-1. Execution of the asset managing application 140-1 in this manner produces processing functionality in an asset managing process 140-2. In other words, the asset managing process 140-2 represents one or more portions of runtime instances of the asset managing application 140-1 (or the entire asset managing application 140-1) performing or executing within or upon the processor 113 in the computerized system 110 at runtime. It is to be understood that embodiments disclosed herein include the applications/software (i.e., the un-executed or non-performing logic instructions and/or data) encoded within a computer readable medium such as a floppy disk, hard disk or in an optical medium, or in a memory type system such as in firmware, read only memory (ROM), or, as in this example, as executable code within the memory system 112 (e.g., within random access memory or RAM). It is also to be understood that other embodiments disclosed herein can provide the applications/software operating within the processor 113 as the processes. While not shown in this example, those skilled in the art will understand that the computer system may include other processes and/or software and hardware components, such as an operating system, that have been left out of this illustration for ease of description.

Further details of configurations explained herein will now be provided with respect to a flow chart of processing steps that show the high level operations disclosed herein to perform the asset managing process 140-2.

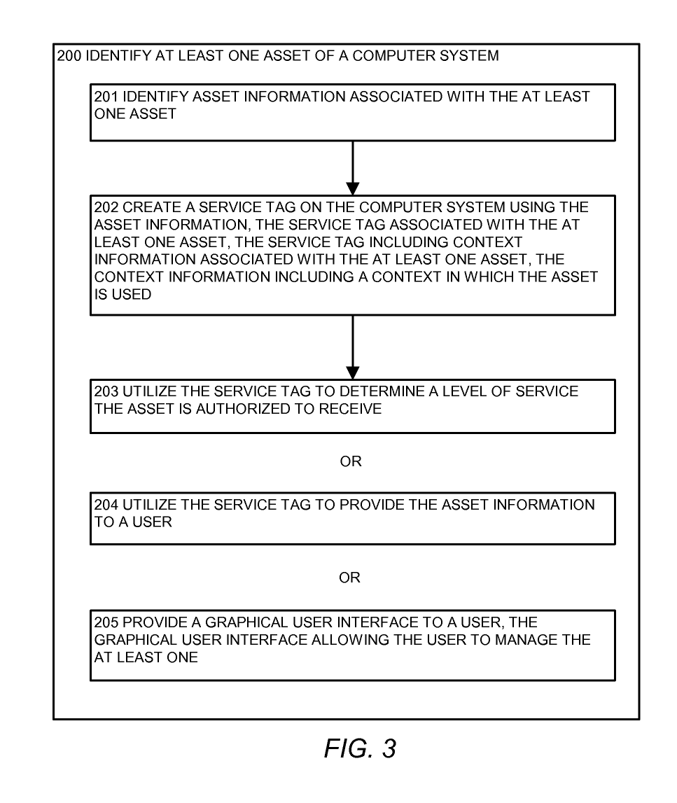

FIG. 3 is an embodiment of the steps performed by the asset managing process 140-2 when it identifies at least one asset 125-1 of a computer system.

In step 200, the asset managing process 140-2 identifies at least one asset 125-1 of a computer system. An agent 120, operating on the computer system, identifies the assets 125-N on the computer system. The assets 125-N may include hardware, an operating system, and software applications, including each instance of a software application. In an example embodiment, the agent 120 is operating on the computer system on which the assets 125-N are discovered. In another example embodiment, the agent 120 is operating on a first computer system and identifies assets 125-N that exist on a second computer system.

In step 201, the asset managing process 140-2 identifies asset information associated with at least one asset 125-1. For example, the asset information may include a product name, product version, the serial number associated with a hardware asset 125-1, etc.

In step 202, the asset managing process 140-2 creates a service tag 135-1 on the computer system using the asset information. The service tag 135-1 is associated with at least one asset 125-1, and includes context information associated with at least one asset 125-1. The context information includes a context in which the asset is used. In an example embodiment, the user may define specific context information (i.e., the context in which the asset 125-1 is used) such as the asset name that the user wishes to associate with that asset. Other context may include such things as CPU type, operating system, amount to memory, etc depending upon what is relevant to the nature of the asset. An example of this includes, for an Operating system asset, the identity of the hardware that it is installed and running on. The agent 120 creates the service tag 135-1 and maintains a registry of all the service tags 135-N.

In step 203, the asset managing process 140-2 utilizes the service tag 135-1 to determine a level of service the asset 125-1 is authorized to receive. In an example embodiment, the service tags 135-N are used in a registration process to register the assets 125-N. Once registered, the service tag 135-1 provides information relating to services the asset 125-1 is authorized to receive. A supplier of the asset 125-1 may provide additional services in exchange for a user registering the asset 125-1. Likewise, the supplier may charge a premium for support of the asset 125-1 if the asset 125-1 is not registered.

Alternatively, in step 204, the asset managing process 140-2 utilizes the service tag 135-1 to provide the asset information to a user. The asset managing process 140-2 provides the user with asset management information including an inventory system. The asset management information allows the user to view and manage a plurality of assets 125-N that exist on the network. Compiling and maintaining an asset inventory system manually would be tedious and susceptible to human error.

Alternatively, in step 205, the asset managing process 140-2 provides a graphical user interface to a user. The graphical user interface allows the user to manage at least one asset 125-1. For example, the graphical user interface renders a graphical representation of each asset 125-1 on the network. The graphical user interface may also display to the user which assets 125-N have been registered and which assets 125-N require registration. The graphical user interface may also provide asset information such as which operation system is running on a computer system, what software applications are installed and what versions of the software applications are installed. The graphical user interface allows the user to perform actions on the assets 125-N (such as registration) in a batch process, saving the user the time needed to individually register each asset 125-1.

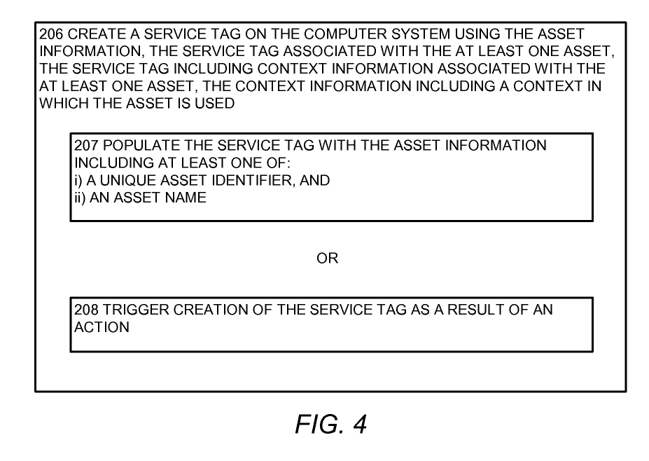

FIG. 4 is an embodiment of the steps performed by the asset managing process 140-2 when it creates a service tag 135-1 on the computer system using the asset information.

In step 206, the asset managing process 140-2 creates a service tag 135-1 on the computer system using the asset information. The service tag 135-1 is associated with at least one asset 125-1, and includes context information associated with at least one asset 125-1. The context information includes a context in which the asset is used. The asset information may also include environment information such as the state of the asset environment at the time the service tag 135-1 is accessed.

In step 207, the asset managing process 140-2 populates the service tag 135-1 with the asset information including at least one of:
i) a unique asset identifier,
ii) a unique product identifier (i.e., the product that the asset is an instance of); and
iii) an asset name.

In an example embodiment, the asset managing process 140-2 generates a unique identifier associated with the asset 125-1. In another example embodiment, the asset managing process 140-2 includes an asset name such that the user easily identifies the asset. For example, on a network, each computer system is typically given a name by which that computer system is referenced (i.e., “BackUp1”). Thus, within the graphical user interface, the asset 125-1 is identified by an asset name easily recognizable by the user. In other words, the user may choose to identify assets by a given asset name, service contract numbers, asset location, etc.

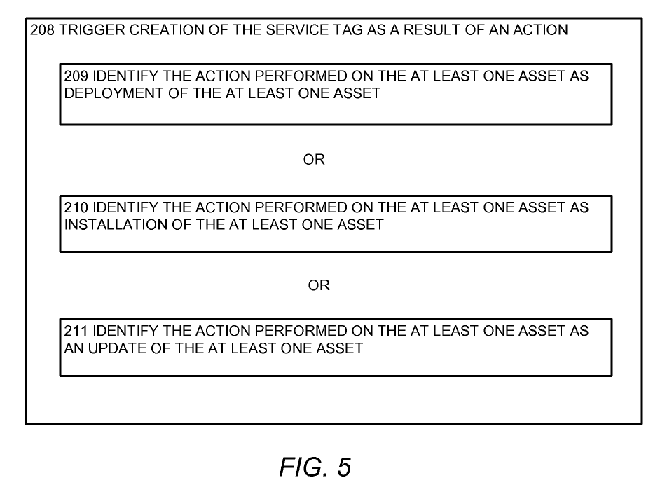

Alternatively, in step 208, the asset managing process 140-2 triggers creation of the service tag 135-1 as a result of an action. The agent 120 creates service tags 135-N when a creation event occurs on the asset 125-1. FIG. 5 illustrates various examples of actions that trigger creation of a service tag 135-1.

FIG. 5 is a continuation of FIG. 4 of an embodiment of the steps performed by the asset managing process 140-2 when it triggers creation of the service tag 135-1 as a result of an action.

In step 209, the asset managing process 140-2 identifies the action performed on at least one asset 125-1 as deployment of at least one asset 125-1. In an example embodiment, a software application is deployed, either manually deployed by a user, or automatically deployed by a process. The deployment of the software application triggers the agent 120 to create a service tag 135-1 for that instance of the software application.

Alternatively, in step 210, the asset managing process 140-2 identifies the action performed on at least one asset 125-1 as installation of at least one asset 125-1. In an example embodiment, an operating system is installed on a computer system. The installation of the operating system triggers the agent 120 to create a service tag 135-1 for that instance of the operating system. That service tag 135-1 has a unique identifier that separates that instance of installation of the operating system from an instance of installation of that same operating system on a different computer system.

Alternatively, in step 211, the asset managing process 140-2 identifies the action performed on at least one asset 125-1 as an update of at least one asset 125-1. In an example embodiment, a software application has been installed on a computer system. An update to that software application is performed. The asset managing process 140-2 determines whether the update of the software application warrants creation of a new service tag 135-1 for that instance of the software application.

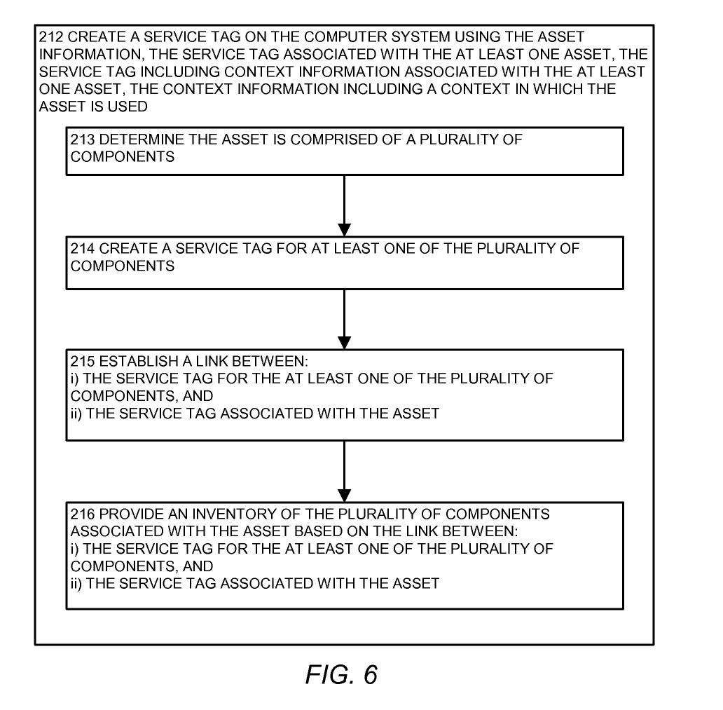

FIG. 6 is an embodiment of the steps performed by the asset managing process 140-2 when it creates a service tag 135-1 on the computer system using the asset information.

In step 212, the asset managing process 140-2 creates a service tag 135-1 on the computer system using the asset information. The service tag 135-1 is associated with at least one asset 125-1, and includes context information associated with at least one asset 125-1. The context information includes a context in which the asset is used. In an example embodiment, the user defines the asset name part of the context information (i.e., the context in which the asset 125-1 is used).

In step 213, the asset managing process 140-2 determines the asset 125-1 is comprised of a plurality of components. For example, the asset 125-1 may be a computer system comprising a plurality of components such as memory cards, software applications, an operating system, etc. In step 214, the asset managing process 140-2 creates a service tag 135-1 for at least one of the plurality of components. In an example embodiment, the asset managing process 140-2 identifies each of the plurality of components associated with the asset 125-1 and creates a service tag 135-1 for each of those components. Thus, a service tag 135-1 is created for the computer system, another service tag 135-1 is created for each of the hardware components (i.e., memory cards, etc.), another service tag 135-1 is created for the operating system, and for each instance of a software application installed on the computer system.

In step 215, the asset managing process 140-2 establishes a link between:
i) the service tag 135-1 for at least one of the plurality of components, and
ii) the service tag 135-1 associated with the asset 125-1.

In an example embodiment, the asset managing process 140-2 establishes a link such that the service tags 135-N for each of the components of the computer system are associated with the service tags 135-N for each of the components in the computer system. Thus, an inventory system provides, for example, information associated with a computer system, along with any software, operating system, etc. loaded on that computer system. The inventor system also provides revision information associated with any software loaded on the computer system, and whether those software applications have been registered.

In step 216, the asset managing process 140-2 provides an inventory of the plurality of components associated with the asset 125-1 based on the link between:
i) the service tag 135-1 for at least one of the plurality of components, and
ii) the service tag 135-1 associated with the asset 125-1.

In an example embodiment, the asset managing process 140-2 provides a graphical user interface to a user. The graphical user interface displays a representation of at least one asset 125-1 in the network. The graphical user interface may display each asset 125-1 along with the components of that asset 125-1. The asset managing process 140-2 tracks each asset 125-1 (and associated components) via the service tag 135-1 that is created for each ass (and each associated component).

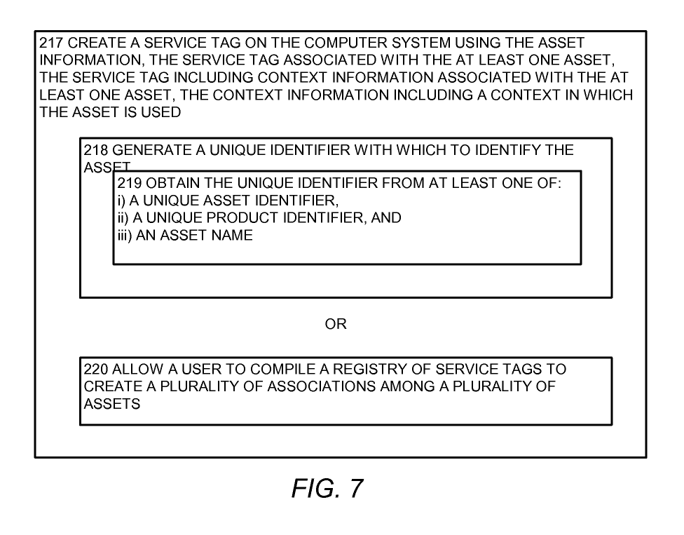

FIG. 7 is an embodiment of the steps performed by the asset managing process 140-2 when it creates a service tag 135-1 on the computer system using the asset information.

In step 217 the asset managing process 140-2 creates a service tag 135-1 on the computer system using the asset information. The service tag 135-1 is associated with at least one asset 125-1, and includes context information associated with at least one asset 125-1. The context information includes a context in which the asset is used.

In step 218, the asset managing process 140-2 generates a unique identifier with which to identify the asset 125-1. During creation of each service tag 135-1, the asset managing process 140-2 generates a unique identifier to identify each asset 125-1 for which the service tag 135-1 represents. In an example embodiment, the unique identifier is generated using a known random alpha numeric string generator.

In step 219, the asset managing process 140-2 obtains the unique identifier from at least one of:
i) the asset 125-1, and
ii) a component associated with the asset 125-1.

In an example embodiment, the asset managing process 140-2 obtains the unique identifier from either the asset 125-1 (such as the serial number of a computer system) or a serial number associated with a component of the asset 125-1.

Alternatively, in step 220, the asset managing process 140-2 allows a user to compile a registry of service tags 135-N. The registry is used to create a plurality of associations among a plurality of assets 125-N. In an example embodiment, the asset managing process 140-2 allows the user to group the assets 125-N. For example, the user may group the assets 125-N according to various technical organizations that exist in the user's company.

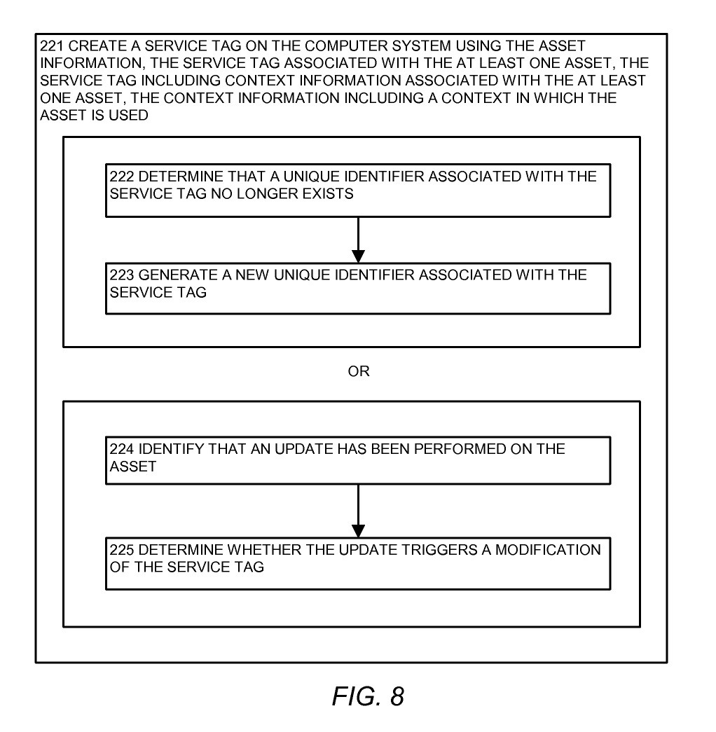

FIG. 8 is an embodiment of the steps performed by the asset managing process 140-2 when it creates a service tag 135-1 on the computer system using the asset information.

In step 221, the asset managing process 140-2 creates a service tag 135-1 on the computer system using the asset information. The service tag 135-1 is associated with at least one asset 125-1, and includes context information associated with at least one asset 125-1. The context information includes a context in which the asset is used.

In step 222, the asset managing process 140-2 determines that a unique identifier associated with the service tag 135-1 no longer exists. In an example embodiment, the service tag 135-1 is stored locally on the asset 125-1, for example a computer system. If the computer system loses data and the service tag 135-1 is lost, the asset managing process 140-2 detects that the unique identifier no longer exists. The asset managing process 140-2 then generates a new service tag 135-1.

In step 223, the asset managing process 140-2 generates a new unique identifier associated with the service tag 135-1. If the determines that that the service tag 135-1 is lost, the asset managing process 140-2 generates a new service tag 135-1.

Alternatively, in step 224, the asset managing process 140-2 identifies that an update has been performed on the asset 125-1. For example, a software update is performed on a software application. The asset managing process 140-2 determines that the asset information associated with that asset has been modified.

In step 225, the asset managing process 140-2 determines whether the update triggers a modification of the service tag 135-1. For example, upon determining that a software update has been performed on a software application (i.e., an asset 125-1), the asset managing process 140-2 determines whether the update is substantial enough to trigger modification to the existing service tag 135-1 or creation of a new service tag 135-1 for that asset 125-1.

While computer systems and methods have been particularly shown and described above with references to configurations thereof, it will be understood by those skilled in the art that various changes in form and details may be made therein without departing from the scope disclosed herein. Accordingly, the information disclosed herein is not intended to be limited by the example configurations provided above.

1. A method of managing assets of a computer system via a computer network, the method comprising:
providing an asset management agent for managing computer system assets;
automatically identifying, by the asset management agent, at least one asset of the computer system, the at least one asset comprising one of an operating system, a software application and a hardware component;
automatically identifying, by the asset management agent, asset information associated with the at least one asset;
automatically creating, by the asset management agent, a service tag using the asset information, the service tag associated with the at least one asset and stored on the computer system, the service tag including context information associated with the at least one asset, the context information including a context in which the asset is used, the context information specifying an asset name and attributes of hardware on which the asset is installed, the attributes including one or more of CPU type, operating system, amount of memory, or identity of the hardware;
automatically utilizing the service tag to determine a level of service that the at least one asset is authorized to receive, including using the service tag in a registration process to register the at least one asset, such that the service tag provides information relating to services with which the at least one asset is authorized; and
automatically creating, by the asset management agent, a new service tag using the asset information if the asset management agent determines that the service tag stored on the computer system is lost.

2. (canceled)

3. The method of claim 1 comprising:
utilizing the service tag to provide the asset information to a user.

4. The method of claim 1 comprising:
providing a graphical user interface to a user, the graphical user interface allowing the user to manage the at least one asset.

5. The method of claim 1 wherein automatically creating a service tag associated with the at least one asset comprises:
populating the service tag with the asset information including at least one of:
i) a unique asset identifier;
ii) a unique product identifier; or
iii) an asset name.

6. The method of claim 1 wherein automatically creating a service tag associated with the at least one asset comprises:
triggering automatically creating the service tag as a result of an action associated with the at least one asset.

7. The method of claim 6 wherein triggering automatically creating of the service tag as a result of an action associated with the at least one asset comprises:
identifying the action associated with the at least one asset as deployment of the at least one asset.

8. The method of claim 6 wherein triggering automatically creating of the service tag as a result of an action associated with the at least one asset comprises:
identifying the action associated with the at least one asset as installation of the at least one asset.

9. The method of claim 6 wherein triggering automatically creating of the service tag as a result of an action associated with the at least one asset comprises:
identifying the action associated with the at least one asset as an update of the at least one asset.

10. The method of claim 1 wherein automatically creating a service tag associated with the at least one asset comprises:
determining that the at least one asset is comprised of a plurality of components; and
creating a service tag for at least one of the plurality of components.

11. The method of claim 10 comprising:
establishing a link between:
i) the service tag for the at least one of the plurality of components; and
ii) the service tag associated with the at least one asset.

12. The method of claim 11 comprising:
providing an inventory of the plurality of components associated with the at least one asset based on the link between:
i) the service tag for the at least one of the plurality of components; and
ii) the service tag associated with the at least one asset.

13. The method of claim 1 wherein automatically creating a service tag associated with the at least one asset comprises:
generating a unique identifier with which to identify the at least one asset.

14. The method of claim 13 wherein generating a unique identifier with which to identify the asset comprises:
obtaining the unique identifier from at least one of:
i) the at least one asset; and
ii) a component associated with the at least one asset.

15. The method of claim 1 wherein automatically creating a service tag associated with the at least one asset comprises:
determining that a unique identifier associated with the service tag no longer exists; and
generating a new unique identifier associated with the service tag.

16. The method of claim 1 wherein automatically creating a service tag associated with the at least one asset comprises:
identifying that an update has been performed on the at least one asset; and
determining whether the update triggers a modification of the service tag.

17. The method of claim 1 wherein automatically creating a service tag associated with the at least one asset comprises:
compiling a registry of service tags to create a plurality of associations among a plurality of assets; and
using the registration process to determine the level of service that the at least one asset is authorized to receive according to the registry of service tags.

18. A computerized device for managing assets of a computer system, the computerized device comprising:
a memory;
a processor;
a communications interface; and
an interconnect mechanism coupling the memory, the processor and the communications interface;
wherein the memory is encoded with an asset managing application that when executed using the processor manages assets on the computer system by performing the operations of:
automatically identifying at least one asset of the computer system, the at least one asset comprising one of an operating system, a software application and a hardware component;
automatically identifying asset information associated with the at least one asset; and
automatically creating a service tag using the asset information, the service tag associated with the at least one asset and stored on the computer system, the service tag including context information associated with the at least one asset, the context information including a context in which the asset is used, the context information specifying an asset name and attributes of hardware on which the asset is installed, the attributes including one or more of CPU type, operating system, amount of memory, or identity of the hardware;
automatically utilizing the service tag to determine a level of service that the at least one asset is authorized to receive, including using the service tag in a registration process to register the at least one asset, such that the service tag provides information relating to services with which the at least one asset is authorized; and
automatically creating a new service tag using the asset information if the asset management application determines that the service tag stored on the computer system is lost.

19. The computerized device of claim 18 wherein the asset managing application further performs the operation of:
providing a graphical user interface to a user, the graphical user interface allowing the user to manage the at least one asset.

20. A non-transitory storage medium having non-transitory computer executable instructions recorded thereon for managing assets of a computer system, the computer executable instructions comprising instructions for:
automatically identifying at least one asset of the computer system, the at least one asset comprising one of an operating system, a software application and a hardware component;
automatically identifying asset information associated with the at least one asset; and
automatically creating a service tag using the asset information, the service tag associated with the at least one asset and stored on the computer system, the service tag including context information associated with the at least one asset, the context information including a context in which the asset is used, the context information specifying an asset name and attributes of hardware on which the asset is installed, the attributes including one or more of CPU type, operating system, amount of memory, or identity of the hardware;
automatically utilizing the service tag to determine a level of service that the at least one asset is authorized to receive, including using the service tag in a registration process to register the at least one asset, such that the service tag provides information relating to services with which the at least one asset is authorized; and
automatically creating a new service tag using the asset information if the service tag stored on the computer system is lost.

21. The method of claim 1, wherein the information relating to services with which the at least one asset is authorized includes one or more services the asset is authorized to receive once the at least one asset is registered.

22. The method of claim 1, further comprising receiving the asset name is received from a user of the asset management agent.

23. The method of claim 1, wherein the attributes include each of the CPU type, the operating system, the amount of memory, and the identity of the hardware.
